(19) United States
(12) Patent Application Publication
(10) Pub. No.: US 2015/0209825 A1
(43) Pub. Date: Jul. 30, 2015

(54) MATERIAL PROCESSING SYSTEM WITH CONDUITS CONFIGURED TO PREVENT HEAT TRANSFER BETWEEN A PYROLYSIS TUBE AND ADJACENT ELEMENTS

(71) Applicant: HZO, Inc., Draper, UT (US)

(72) Inventors: James Dempster, Reno, NV (US); Yang Yun, Draper, UT (US); Max Sorenson, Cottonwood Heights, UT (US)

(21) Appl. No.: 14/607,937

(22) Filed: Jan. 28, 2015

Related U.S. Application Data
(60) Provisional application No. 61/932,769, filed on Jan. 28, 2014.

(51) Int. Cl. B05D 1/00; B05D 7/26; B05B 17/04; B05B 9/04; B05B 9/00

(52) U.S. Cl. CPC B05D 1/60; B05B 9/04; B05B 9/002; B05B 17/04; B05D 7/26

(57) ABSTRACT

A material processing system that prevents transmission of infrared radiation from its pyrolysis tube to one or more adjacent elements, such as a vaporization chamber or a deposition chamber, is disclosed. Such a material processing system may include at least one conduit with a non-linear element. The non-linear element of such a conduit may preclude the presence of a line-of-sight through the length of the conduit. The non-linear element may also have a shape that enables gas or vapor to flow therethrough with little or no turbulence, which, in embodiments where part or all of the material processing system lacks valves, enables the gas or vapor to flow freely through the material processing system, or at least through the valveless portion thereof.

### CROSS-REFERENCE TO RELATED APPLICATION

A claim for the benefit of priority to the Jan. 28, 2014 filing date of U.S. Provisional Patent Application No. 61/932,769, titled MATERIAL PROCESSING SYSTEM INCLUDING A BEND IN A CONDUIT BETWEEN A PYROLYSIS TUBE AND AN ADJACENT CHAMBER (“the '769 Provisional Application”) is hereby made pursuant to 35 U.S.C. §119(e). The entire disclosure of the '769 Provisional Application is hereby incorporated herein.

### TECHNICAL FIELD

This disclosure relates generally to apparatuses, systems (including material processing systems) and methods for forming protecting coatings. More particularly, this disclosure relate to apparatuses, systems and methods for selectively forming protective coatings, including moisture-resistant coatings, on substrates, such as electronic devices and their components. More particularly still, material processing systems are disclosed that include one or more conduits that are shaped, or configured, to prevent infrared radiation emitted from pyrolysis tube, or “pyrolyzer,” from being transmitted into and an adjacent element, such as a vaporizer and/or a deposition chamber and, thus, to prevent the infrared radiation from undesirably heating the adjacent element.

### BACKGROUND

With the increased development of semiconductor technology, electronic devices have played an ever-increasing role in modern life. Mobile phones, digital cameras, digital media players, tablet computers, wearable electronic devices and the like are currently very common, and their use continues to expand. For example, mobile phones have become important equipment in the lives of an office worker, particularly with the advent of so-called smart phones which allow a person to not only make and receive phone calls, but also to send and receive e-mail or other electronic messages, browse the Internet or other networks, view and create calendar events, view and edit documents and the like. Mobile phones and other portable devices are also commonly used outside of an office setting.

As the use of portable electronic devices has increased, so has the likelihood that they will be damaged. In particular, unlike a desktop computer or other device with limited portability, a mobile device may be repeatedly subjected to different types of environments, it may be dropped or it may be subjected to other potentially damaging conditions. For instance, when carrying a smart phone, a laptop, an e-reader, a digital camera, a tablet computer, or another portable electronic device, the portable electronic device may be exposed to water from rain or other environmental conditions, or the device may accidentally be dropped into a puddle, sink, toilet, or another wet location.

Damage to an electronic device (portable or otherwise) may impair its functionality or may cause the electronic device to cease operating entirely. Electronic devices may be expensive to replace. In the context of mobile phones, mobile phone carriers may subsidize a portion of the purchase price of the mobile phone, but typically only provide the subsidy once every eighteen to twenty-four months. If the mobile phone is damaged prior to the time another subsidy will be provided by the mobile phone carrier, the user may have to bear the expense of replacing or repairing the mobile phone. Moreover, exposure of components of an electronic device to water or other types of moisture can also void the warranty on the electronic device, leaving a user with little choice but to do without the electronic device or to expend significant sums of money to repair or replace the electronic device.

Although removable cases have been developed for some portable electronic devices, removable cases often do not offer full protection against water, other types of moisture or other factors that may damage the portable electronic device. As a result, when a portable electronic device is exposed to water, other types of moisture or other sources of potential damage, the source of potential damage can find its way (e.g., leak, etc.) into the portable electronic device and damage components of the portable electronic device. Some protective cases may also make a device waterproof, but waterproof cases are often bulky and add significantly to the weight or size of the portable electronic device, taking away from the sleek appearance of the portable electronic device. In addition, waterproof cases are typically configured to prevent moisture from reaching the ports of a portable electronic device and, consequently, make it more difficult for a user to access and use the ports of the portable electronic device. For these and other reasons, many users avoid using waterproof cases.

As an alternative to the use of waterproof cases, moisture-resistance technologies have been developed for protecting the sensitive components within electronic devices. One example of such a technology is the parylene coating technology that has been developed by HZO, Inc. of Draper, Utah. Protective coating processes, like HZO's, may be integrated into assembly, refurbishing and remanufacturing processes, which are typically high-throughput, time-sensitive processes. The greater the ability to maintain precise, or tight, control over processes for depositing parylene and other types of protective, the easier it is to incorporate protective coating processes into existing assembly, refurbishing and remanufacturing processes.

Unfortunately, the high temperatures that are generated by pyrolysis tubes of material processing systems used to deposit parylene coatings radiates to adjacent elements, making it difficult to control the temperatures and operation of the adjacent elements. Since the pyrolysis tube of such equipment typically operates at a much higher temperature than adjacent components (e.g., a vaporizer upstream from the pyrolysis tube, a deposition chamber downstream from the pyrolysis tube, etc.), heating of these adjacent elements reduces control over their temperatures, which may have undesirable effects on the quality and other characteristics of the film that is deposited. For example, the uncontrolled addition of heat to a vaporizer may cause undesired variations in the rate at which a precursor material is vaporized. As another example, increasing the temperature of a deposition chamber may affect the manner in which reactive species polymerize on the surface of a substrate, which may affect the appearance and/or quality of a film formed on the substrate.

Conversely, heat generated by the adjacent elements of such a material processing system (e.g., a vaporizer, etc.) may also radiate to, and affect, the temperature of the pyrolysis tube, which may reduce control over the temperature of the pyrolysis tube and, thus, have a detrimental effect on the quality of the material(s) exiting the pyrolysis tube. For example, an uncontrolled decrease in the temperature of a pyrolysis tube may result in under-cracking of a precursor material, which limits the concentration of reactive species that are available for polymerization on a substrate within the deposition chamber and may also contaminate the polymer with unreacted precursor material. An uncontrolled increase in the temperature of a pyrolysis tube may cause over-cracking of the precursor material into species that do not polymerize as intended, and that may also reduce the quality of the resulting polymer.

Better temperature control has been achieved, to varying degrees, by incorporating valves between the various elements, or components, of material processing systems. The use of valves is somewhat undesirable, however, in that they are relatively complex structures (as opposed to the interior of a conduit) that require periodic, if not frequent, cleaning. Valves also add to the complexity of a material processing system, which increases the complexity of the manner in which it operates, and its difficulty of operation, as well as its need for maintenance (i.e., valves can fail). Thus, the inclusion of valves in a material processing system can be problematic and undesirable, particularly in the high throughput systems that are needed to efficiently apply protective coatings to large batches of electronic devices.

### SUMMARY

In accordance with some embodiments of the present disclosure, a material processing system that may be configured to apply a protective coating (e.g., a parylene, or an unsubstituted or substituted poly(p-xylylene), etc.) to a substrate (e.g., deposit the protective coating onto the substrate, etc.), may include a pyrolysis tube, which is also referred to as a “pyrolyzer,” and one or more adjacent elements or components. In some embodiments, the material processing system may comprise a material deposition system. The material processing system may be configured in a manner that prevents or limits the transmission of infrared (IR) radiation from the pyrolysis tube to at least one adjacent component.

Without limitation, one of the adjacent elements, or components, of a material processing system may comprise a vaporization chamber, or a “vaporizer,” upstream from the pyrolysis tube, for receiving a precursor material (e.g., a parylene dimer, or an unsubstituted [2.2]paracyclophane and/or a substituted [2.2]paracyclophane, etc.) into the material processing system. A conduit, which may be referred to as a “vapor transport conduit,” establishes communication between the vaporization chamber and a first end, or an input end, of the pyrolysis tube. The vapor transport conduit may include a non-linear element, which may have a reduced line-of-sight relative to a linear conduit or which may lack any line-of-sight. Thus, a shape of the vapor transport (or a shape of its non-linear element) may limit or preclude the transmission of infrared radiation from the pyrolysis tube to the vaporization chamber and, therefore, limit the extent of any effect such infrared radiation may have on a temperature of the vaporization chamber.

A material processing system may also include a deposition chamber downstream from the pyrolysis tube, into which reactive species (e.g., parylene monomers, or p-xylylene, etc.) are introduced and deposited onto one or more substrates. A second end, or an exit end, of the pyrolysis tube may be coupled to the deposition chamber by way of a conduit, which may be referred to as a “reactive species transport conduit.” The reactive species transport conduit may include at least one non-linear element, providing a non-linear path between the pyrolysis tube and the deposition chamber. The non-linear element, which may limit or eliminate any line-of-sight along the path through the reactive species transport conduit, may be configured to at least partially block infrared radiation emitted from the pyrolysis tube, and prevent the infrared radiation from reaching and, thus, heating the deposition chamber.

A bent conduit may also prevent infrared radiation from another source, such as the vaporization chamber, from reaching and, thus, heating the pyrolysis tube. By effectively isolating the pyrolysis tube from an adjacent element of the material processing system (e.g., an adjacent chamber, etc.) and, thus, from infrared radiation emitted by the adjacent element, control over the temperature of the pyrolysis tube, the adjacent element or both may be improved.

In embodiments where the shape of a conduit reduces line-of-sight relative to a straight conduit, but does not totally eliminate line-of-sight, the shape of the conduit may be tailored to transmit a predetermined percentage of infrared radiation emitted from the pyrolysis tube to an element adjacent to the pyrolysis tube. Such a configuration may enable use of infrared radiation from the pyrolysis tube to heat, or at least partially heat, the adjacent element in a controlled manner.

A material processing system according to this disclosure may lack any valves between its vaporization chamber and its pyrolysis tube. Thus, depending upon a shape of the vapor transport conduit, which may minimize turbulence, a vaporized precursor material may flow freely from the vaporization chamber to the pyrolysis tube. Similarly, a material processing system may lack valves between its pyrolysis tube and its deposition chamber, which may, along with a shape of the reactive species transport conduit that minimizes turbulence, enable reactive species that have been generated by the pyrolysis tube to flow freely from the pyrolysis tube to the deposition chamber. In some embodiments, there may be no valves between the vaporization chamber and the deposition chamber of a material processing system. Thus, the application of a vacuum to the deposition chamber may draw material through the entire material processing system (i.e., from the vaporization chamber to the deposition chamber) at a substantially constant rate of flow.

According to some more specific embodiments, a material processing system according to this disclosure may include a vaporization chamber configured for vaporizing a precursor material (e.g., a parylene dimer, etc.), a pyrolysis tube configured for heating vaporized precursor material to break, or split or “crack,” the vaporized precursor material into reactive units (e.g., parylene monomers, etc.), and a deposition chamber configured to deposit the reactive units onto a substrate. The pyrolysis tube may be coupled to the vaporization chamber via a first conduit, or a vapor transport conduit, that includes a single bend (e.g., a bend forming an angle of less than 180°, a bend of about 150°, a bend of about 135°, a bend of about 120°, a bend of about 90°, etc.). The pyrolysis tube may also be coupled to the deposition chamber via a second conduit, or a reactive species transport conduit, that includes a single bend (e.g., a bend forming an angle of less than 180°, a bend of about 150°, a bend of about 135°, a bend of about 120°, a bend of about 90°, etc.). Each bend may be configured to block at least a portion of the infrared radiation emitted from the pyrolysis chamber and/or to block at least a portion of the infrared radiation emitted by the adjacent element (i.e., the vaporization chamber or the deposition chamber).

In other embodiments, one or both of a vapor transport conduit and/or a reactive species transport conduit of a material processing system may include more than one bend. In some embodiments, a plurality of bends may define a non-linear element that has a serpentine configuration or a substantially serpentine configuration. Without limitation, a substantially serpentine configuration may be defined by a pair of elbows (e.g., 45° elbows (which provide for 135° bends), etc.) that are arranged in a manner that positions end portions of the length of the conduit substantially parallel to one another.

According to another aspect, methods for operating a material processing system to apply a protective coating to a substrate are disclosed. Various embodiments of such a method may include heating a precursor material (e.g., a parylene dimer, etc.) within a vaporization chamber to vaporize or sublimate the precursor material. The precursor material, in the form of a vapor, may then be drawn into a pyrolysis tube to break, or split or crack, the precursor material into reactive units (e.g., parylene monomers, etc.). The method may further include blocking, or preventing transmission of, at least a portion of the infrared radiation emitted from the pyrolysis tube to and adjacent element. Such blocking may be achieved by including a non-linear element (e.g., one or more bends, etc.) in a conduit coupling the pyrolysis tube to the adjacent element while allowing the vaporized precursor material to flow freely from the adjacent element to the pyrolysis tube or from the pyrolysis tube to the adjacent element. More specifically, the method may include blocking at least a portion of the infrared radiation from the pyrolysis tube from being transmitted to a vaporization chamber to enable improved control over a temperature of the vaporization chamber. Alternatively, or in addition, the method may include blocking at least a portion of the infrared radiation from the pyrolysis tube from being transmitted to a deposition chamber of the material processing system, which may prevent the deposition chamber from being heated to a temperature that might otherwise have a detrimental effect on the polymer that is being deposited or on the substrates onto which the polymer is being deposited, and may provide for improved control over the temperature of the deposition chamber.

Other aspects of the disclosed subject matter, as well as features and advantages of various aspects of that subject matter, will become apparent to those of ordinary skill in the art through consideration of the ensuing description, the accompanying drawings and the appended claims.

### BRIEF DESCRIPTION OF THE DRAWINGS

In the drawings:

FIG. 1 illustrates a material processing system;

FIG. 2 illustrates an embodiment of a material processing system, which includes a vaporizer, a pyrolyzer and a deposition chamber, as well as bent conduits between the vaporizer and the pyrolyzer and between the pyrolyzer and the deposition chamber;

FIG. 3 depicts another embodiment of material processing system with conduits that include non-linear elements between a vaporizer and a pyrolyzer and between the pyrolyzer and a deposition chamber;

FIG. 4 illustrates an embodiment of material processing system that includes a conventional conduit between a vaporizer and a pyrolyzer, as well as a conduit with a non-linear element between the pyrolyzer and a deposition chamber; and

FIG. 5 provides a schematic representation of an embodiment of a material processing system in which a conduit between a vaporizer and a pyrolyzer includes at least one non-linear element, but a conduit between the pyrolyzer and a deposition chamber has a conventional shape, or configuration.

### DETAILED DESCRIPTION

Devices, systems, and methods of the present disclosure include one or more elements used for placing protective coatings on substrates. A few examples of substrates to which protective coatings may be applied include, but are not limited to, electronic devices or components thereof (e.g., portable electronic devices, wearable electronic devices, implantable electronic devices (e.g., medical devices, etc.), etc.), other devices that are sensitive to moisture and/or contamination, medical devices, articles of clothing, etc.

As used herein, a “substrate” may be a material, component, assembly (e.g., an electronic subassembly, an electronic assembly, etc.), or other element to which a protective coating is applied. In accordance with some examples, the substrate may include one or more electronic components. As an example, a substrate including a single electronic component, or a combination of multiple electronic components, may be intended for use in an electronic device assembly that is itself all or a portion of an electronic device. The electronic device assembly may have one or more surfaces that could benefit from the application of a protective coating, including surfaces susceptible to damage if contacted by water or another type of moisture. Other examples of substrates include wearable electronic devices, implantable electronic devices, industrial electronic devices, electronic devices that are used in aircraft, vehicles and other types of equipment, etc.), medical devices and other devices that are sensitive to moisture and/or contamination. Aspects of the present disclosure relate to apparatuses, systems and methods for applying a protective coating to a substrate to mitigate such susceptibility. In some cases, a protective coating can be applied to interior components of an electronic device, whether prior to subassembly of a part of the electronic device, prior to complete assembly of the electronic device or after assembly and subsequent partial disassembly of the electronic device.

The protective materials that may be applied to surfaces of a substrate may impart at least a portion of the substrate with moisture resistance. As used herein, the term “protective coating” includes moisture resistant coatings or films, as well as other coatings or films that protect various parts of a substrate from moisture and/or other external influences. While the term “moisture-resistant coating” is used throughout this disclosure, in many, if not all, circumstances, a moisture-resistant coating may comprise or be substituted with a protective coating that protects coated components and/or features from other external influences. The term “moisture-resistant” refers to the ability of a coating to prevent exposure of a coated element or feature to moisture. A moisture-resistant coating may resist wetting or penetration by one or more types of moisture, or it may be impermeable or substantially impermeable to one or more types of moisture. A moisture-resistant coating may repel one or more types of moisture. In some embodiments, a moisture-resistant coating may be impermeable to, substantially impermeable to or repel water, an aqueous solution (e.g., salt solutions, acidic solutions, basic solutions, drinks, etc.) or vapors of water or other aqueous materials (e.g., humidity, fogs, mists, etc.), wetness, etc.). Use of the term “moisture-resistant” to modify the term “coating” should not be considered to limit the scope of materials from which the coating protects one or more components of an electronic device or any other substrate. The term “moisture-resistant” may also refer to the ability of a coating to restrict permeation of or repel organic liquids or vapors (e.g., organic solvents, other organic materials in liquid or vapor form, etc.), as well as a variety of other substances or conditions that might pose a threat to a substrate, such as an electronic device, or to components of the substrate.

A protective coating may be applied selectively to some, but not all, portions of a substrate. For instance, an assembly may include multiple electronic components connected by one or more interfaces, connectors (e.g., ribbon connectors, zero insertion force (ZIF) connectors, etc.), ports and the like. The protective coating could prevent or limit electrical contact between different components. Accordingly, the protective coating may not be applied where it would restrict electrical contact or other beneficial or otherwise desired connections or features. In accordance with some embodiments of this disclosure, systems, methods and devices may be provided for selectively applying the protective coating to only desired portions of the substrate. In other embodiments, a protective coating may be applied to an entire surface of a substrate or to the entire substrate.

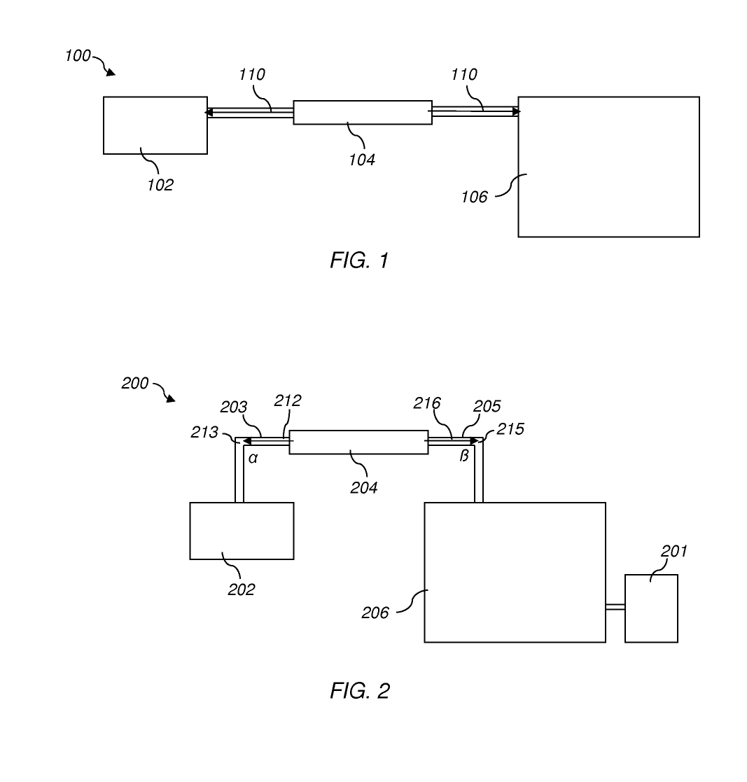

FIG. 1 illustrates a conventional material processing system 100 that includes a vaporization chamber 102, a pyrolysis tube 104, and a deposition chamber 106. As will be appreciated by a person of ordinary skill in the art, the pyrolysis tube 104 may emit infrared radiation (depicted by arrows 110) that may heat any exposed surface in its linear, line-of-sight path. The infrared radiation may heat the vaporization chamber 102 to an undesirably high temperature, reduce control over a temperature of the vaporization chamber 102 and/or otherwise undesirably affect the operation of the vaporization chamber 102. In turn, these effects may reduce control over the manner in which a precursor material within vaporization chamber 102 vaporizes or sublimates (e.g., by causing variations in the rate at which the precursor material vaporizes or sublimate, by causing an undesirably large amount of the precursor material to prematurely vaporize or sublimate, etc.), which may have an undesirable effect on the manner in which a protective coating is deposited onto a substrate within the deposition chamber 106, which may result in a low quality protective coating.

In accordance with various embodiments of this disclosure, a material processing system 200 may be configured to block at least a portion of the infrared radiation originating from a pyrolysis tube 204 of the material processing system 200. FIG. 2 depicts an embodiment of a material processing system 200 that includes a vaporization chamber 202, a pyrolysis tube 204 and a deposition chamber 206. In a specific embodiment, which should not in any way be considered to limit the scope of this disclosure or of any of the appended claims, a precursor material to a protective material, which may comprise a polymer (e.g., poly(p-xylylene), or parylene, etc.), may be supplied to the material processing system 200 by introducing the precursor material (e.g., paracyclophane or an unsubstituted or substituted analog thereof, which is also referred to in the art as a “parylene dimer,” etc.) into vaporization chamber 202. The vaporization chamber 202 of such a material processing system 200 may be configured to operate at a predetermined temperature or over a predetermined range of temperatures (e.g., less than 250° C., less than 225° C., less than 200° C., less than 175° C., at about 170° C., at about 165° C., at about 160° C., etc.).

Once the precursor material has been vaporized or sublimated in the vaporization chamber 202, the precursor material, in vapor form, may flow through a conduit, which is also referred to herein as a “vapor transport conduit 203,” into the pyrolysis tube 204. In the pyrolysis tube 204, the vaporized precursor material may be heated (e.g., to a temperature of about 400° C. or more, to a temperature of about 450° C. or more, to a temperature of about 550° C. or more, to a temperature of about 600° C. or more, to a temperature of about 650° C. or more, to a temperature of about 700° C. or more, etc.) to form reactive species.

The pyrolysis tube 204 may communicate the reactive species along another conduit, which is referred to herein as a “reactive species transport conduit 205,” and to the deposition chamber 206. The reactive species may ultimately be deposited onto a substrate (not shown in FIG. 2) and polymerize to form a protective coating on the substrate. The temperature within the deposition chamber 206 at the time substrates are present there in and reactive species are introduced there may be a temperature that will not damage the substrates and that will enable polymerization to occur and a film of suitable quality to form on the substrates. Without limitation, in embodiments where a parylene coating is to be deposited onto one or more substrates within the interior of the deposition chamber 206, the interior of the deposition chamber 206 may be maintained at an ambient temperature (e.g., 22° C. to 30° C., about 25° C., about 26° C., about 27° C., about 28° C., etc.) or a substantially ambient temperature (e.g., about 30° C., about 30° C. or less, etc.) or any other suitable temperature (e.g., about 40° C. or less, about 50° C. or less, etc.) while introducing reactive species into the deposition chamber 206.

The material processing system 200 may further include one or more vacuum pumps 201 and other elements that may facilitate material flow through the material processing system 200, as well as the generation of reactive species and the deposition and polymerization of an organic polymer or other protective coating onto the substrate.

An angle α may exist along the vapor transport conduit 203 between the vaporization chamber 202 and the pyrolysis tube 204. More specifically, the vapor transport conduit 203 connecting the vaporization chamber 202 and the pyrolysis tube 204 may include a bend 213 forming angle α. The bend 213 of the vapor transport conduit 203 may be configured to prevent at least a portion of the infrared radiation (designated by arrow 212) emitted by the pyrolysis chamber 204 from reaching the vaporization chamber 202. The bend 213 may prevent infrared radiation from the vaporization chamber 202 from reaching the pyrolysis tube 204.

An angle β may exist along the reactive species transport conduit 205 between the pyrolysis tube 204 and the deposition chamber 206. More specifically, the reactive species transport conduit 205, which connects the pyrolysis tube 204 and the deposition chamber 206, may include a bend 215 forming angle β. The bend 215 of the reactive species transport conduit 205 may be configured to prevent at least a portion of the infrared radiation (designated by arrow 216), emitted by the pyrolysis chamber 204 from reaching the deposition chamber 206.

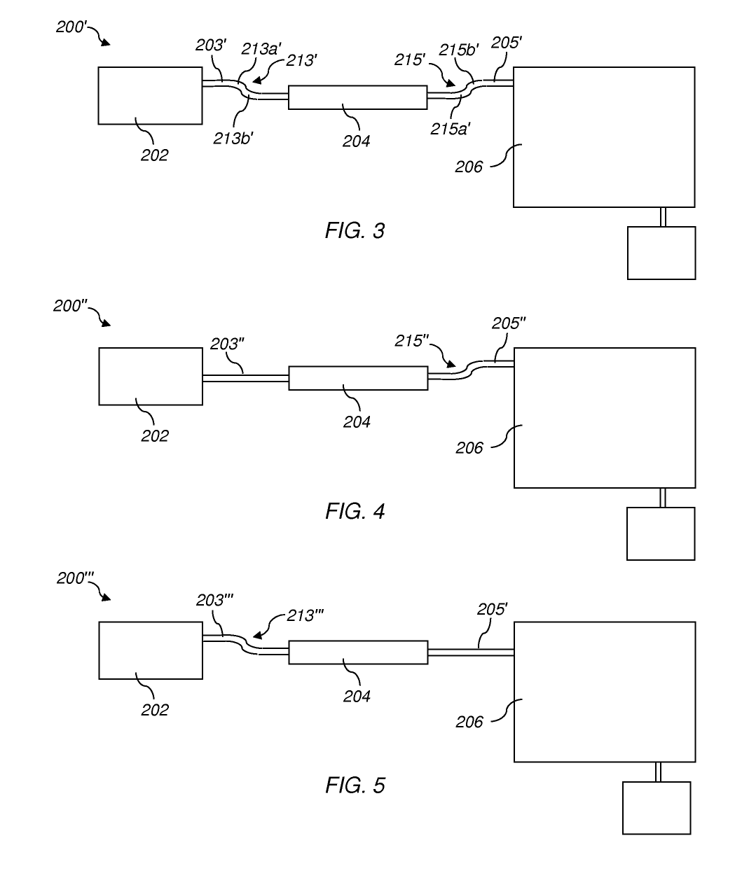

It is noted that although angles α and β are illustrated by FIG. 2 as measuring 90°, the present disclosure is not so limited. Rather, as depicted by FIGS. 3-5, angle α and/or angle β may comprise any angle less than 180°, a conduit may include any other suitable type of non-linearity (e.g., a curved bend, etc.) or a conduit may include two or more bends or other non-linear elements.

With reference to FIG. 3, an embodiment of material processing system 200′ is illustrated in which a vapor transport conduit 203′ establishes communication between a vaporization chamber 202 and an input end of a pyrolysis tube 204. As illustrated, the vapor transport conduit 203′ includes at least one non-linear element 213′. The non-linear element 213′ may have a sigmoidal shape or a substantially sigmoidal shape (i.e., the non-linear element 213′ may include at least two bends that cause ends of the vapor transport conduit 213′ to extend in generally opposite directions from one another). Such a shape may be defined by a pair of elbows 213a′ and 213b′, such as the 45° elbows (which form 135° bends), depicted by FIG. 3.

A reactive species transport conduit 205′, which is configured to convey reactive species from an exit end of the pyrolysis tube 204 to a deposition chamber 206, may also include one or more non-linear elements 215′. The non-linear element 215′ of the reactive species transport conduit 205′ may be configured in the same manner as the non-linear element 213′ of the vapor transport conduit 203′, as shown in FIG. 3, or in a different manner.

Turning now to FIG. 4, another embodiment of a material processing system 200″ is shown. That embodiment of material processing system 200″ includes a conventional (i.e., straight) vapor transport conduit 203″ between its vaporization chamber 202 and the input end of its pyrolysis tube 204, and a non-linear reactive species transport conduit 205″ between an exit end of the pyrolysis tube 204 and a deposition chamber 206. FIG. 4 depicts the reactive species transport conduit 205″ as including a non-linear element 215″ with a sigmoidal or substantially sigmoidal shape. However, a material processing system 200″ may include a reactive species transport conduit 205″ with any other non-linear shape.

FIG. 5 illustrates yet another embodiment of material processing system 200′″, in which a vapor transport conduit 203′″ is non-linear, while a reactive species transport conduit 205′″ may have a conventional configuration (i.e., it may be straight). More specifically, the vapor transport conduit 203′″ may include a non-linear element 213′″, which, in some embodiments, may have a sigmoidal or substantially sigmoidal shape, or, in other embodiments, have any other non-linear shape.

The remaining elements (e.g., the vaporization chamber 202, the pyrolysis tube 204, the deposition chamber 206, the vacuum pump 208, etc.) of the material processing systems 200′, 200″ and 200′″ shown in FIGS. 3-5, respectively, may be configured, and may operate, in any suitable manner, including, without limitation, in any manner disclosed hereinabove in reference to the material processing system 200 shown in FIG. 2.

As will be appreciated by a person of ordinary skill in the art, each bend or other non-linear element along the length of a conduit may prevent infrared radiation originating from the pyrolysis tube 204 from heating a precursor material (e.g., a parylene dimer, etc.) within the vaporization chamber 202. This, in turn, may prevent a loss of control over the rate at which the precursor material is vaporized or sublimated, and may prevent other adverse effects. Thus, the inclusion of a bend or another suitable non-linear element in a conduit between the vaporization chamber 202 and the pyrolysis tube 204 and/or between the pyrolysis tube 204 and the deposition chamber 206 may improve the controllability with which a protective coating is formed. Further, the presence of a non-linear element along the conduit between the pyrolysis tube 204 and the deposition chamber 206 may prevent infrared radiation from pyrolysis tube 204 from undesirably heating a substrate within deposition chamber 206, which may improve a quality of the protective coating.

Various embodiments of apparatuses, systems and methods disclosed herein may improve the manner in which precursor materials are processed (e.g., vaporized or sublimated, pyrolyzed, deposited, etc.). For example, an apparatus, system and/or method of this disclosure may provide for improved precision in process control, including control over process rates (e.g., uniform process rates, process rates that follow a predetermined profile, etc.). The disclosed apparatus, systems and/or methods may also enable processing (e.g., conformal coating of a large number of substrates, such as electronic components, electronic component assemblies, electronic devices, etc.).

Although the foregoing disclosure provides many specifics, these should not be construed as limiting the scope of any of the appended claims, but merely as providing information pertinent to some specific embodiments that may fall within the scopes of the claims. Other embodiments may be devised which lie within the scopes of the claims. Features from different embodiments may be employed in any combination. All additions, deletions and modifications, as disclosed herein, that fall within the scopes of the claims are to be embraced by the claims.

What is claimed:

1. A material deposition system comprising:
a vaporizer;
a vapor transport conduit including a first end in communication with the vaporizer, the vapor transport conduit extending from the vaporizer and comprising a non-linear element with a substantially sigmoidal shape that precludes line-of-sight through an entirety of a length of the vapor transport conduit;
a pyrolyzer including a first end in communication with a second end of the vapor transport conduit;
a reactive species transport conduit including a first end in communication with a second end of the pyrolyzer, the reactive species transport conduit comprising a non-linear element with a substantially sigmoidal shape that precludes line-of-sight through an entirety of a length of the reactive species transport conduit; and
a deposition chamber in communication with a second end of the reactive species transport conduit.

2. The material deposition system of claim 1, wherein the non-linear element of the vapor transport conduit is configured to enable a vaporized precursor material to flow freely from the vaporizer to the pyrolyzer.

3. The material deposition system of claim 1, wherein the non-linear element of the vapor transport conduit is configured to prevent transmission of infrared radiation from the pyrolyzer to the vaporizer.

4. The material deposition system of claim 1, wherein the non-linear element of the vapor transport conduit comprises a pair of 45° elbows.

5. The material deposition system of claim 1, lacking any valves between the vaporizer and the pyrolyzer.

6. The material deposition system of claim 1, wherein the non-linear element of the reactive species transport conduit is configured to enable reactive species to flow freely from the pyrolyzer to the deposition chamber.

7. The material deposition system of claim 1, wherein the non-linear element of the reactive species transport conduit is configured to prevent transmission of infrared radiation from the pyrolyzer to the deposition chamber.

8. The material deposition system of claim 1, wherein the non-linear element of the reactive species transport conduit comprises a pair of 45° elbows.

9. The material deposition system of claim 1, lacking any valves between the pyrolyzer and the deposition chamber.

10. A material deposition system comprising:
a vaporizer;
a vapor transport conduit including a first end in communication with the vaporizer, the vapor transport conduit extending from the vaporizer and comprising a non-linear element that precludes line-of-sight through an entirety of a length of the vapor transport conduit;
a pyrolyzer including a first end in communication with a second end of the vapor transport conduit;
a reactive species transport conduit including a first end in communication with a second end of the pyrolyzer, the reactive species transport conduit comprising a non-linear element that precludes line-of-sight through an entirety of a length of the reactive species transport conduit; and
a deposition chamber in communication with a second end of the reactive species transport conduit,
the material deposition system lacking valves along a flow path that extends from the vaporizer, through the vapor transport conduit, through the pyrolyzer, through the reactive spaces transport conduit and into the deposition chamber.

11. The material deposition system of claim 10, wherein the non-linear element of the vapor transport conduit includes a plurality of bends.

12. The material deposition system of claim 11, wherein the non-linear element of the vapor transport conduit is substantially sigmoidal in shape.

13. The material deposition system of claim 12, wherein the non-linear element of the vapor transport conduit comprises a pair of 45° elbows.

14. The material deposition system of claim 10, wherein the non-linear element of the vapor transport conduit includes a single bend.

15. The material deposition system of claim 14, wherein the non-linear element of the vapor transport conduit includes a 90° bend.

16. The material deposition system of claim 10, wherein the non-linear element of the reactive species transport conduit includes a plurality of bends.

17. The material deposition system of claim 16, wherein the non-linear element of the reactive species transport conduit is substantially sigmoidal in shape.

18. The material deposition system of claim 17, wherein the non-linear element of the reactive species transport conduit comprises a pair of 45° elbows.

19. The material deposition system of claim 10, wherein the non-linear element of the reactive species transport conduit includes a single bend.

20. The material deposition system of claim 19, wherein the non-linear element of the reactive species transport conduit includes a 90° bend.

21. A material deposition system comprising:
a vaporizer;
a vapor transport conduit including a first end in communication with the vaporizer, the vapor transport conduit extending from the vaporizer;
a pyrolyzer including a first end in communication with a second end of the vapor transport conduit;
a reactive species transport conduit including a first end in communication with a second end of the pyrolyzer; and
a deposition chamber in communication with a second end of the reactive species transport conduit,
at least one of the vapor transport conduit and the reactive species transport conduit comprising a non-linear element with a substantially sigmoidal shape that at least partially precludes line-of-sight through an entirety of a length of the vapor transport conduit and/or the reactive species transport conduit.

22. The material deposition system of claim 21, wherein the non-linear element completely precludes line-of-sight though an entirety of the length of the vapor transport conduit and/or the reactive species transport conduit.

23. The material deposition system of claim 21, wherein the non-linear element comprises a pair of 45° elbows.

24. The material deposition system of claim 21, lacking any valves between the vaporizer and the deposition chamber.

25. The material deposition system of claim 21, lacking any valves between the pyrolyzer and the deposition chamber.

26. A method for depositing a polymer onto a substrate, comprising:
introducing a precursor material into a vaporizer of a material deposition system;
heating the precursor material in the vaporizer to provide a vaporized precursor material;
enabling the vaporized precursor material to flow freely from the vaporizer, into and through a vapor transport conduit and into a pyrolyzer;
heating the pyrolyzer to create reactive species from vaporized precursor material within the pyrolyzer, a shape of the vapor transport conduit preventing transmission of infrared radiation from the pyrolyzer into the vaporizer;
enabling the reactive species to flow freely from the pyrolyzer, into and through a reactive species transport conduit and into a deposition chamber, a shape of the reactive species transport conduit preventing transmission of infrared radiation from the pyrolyzer into the deposition chamber; and
applying a vacuum to the deposition chamber to draw the vaporized precursor material out of the vaporizer, into and through the vapor transport conduit and into and through the pyrolyzer and to draw the reactive species from the pyrolyzer, into and through the reactive species transport conduit and into the deposition chamber.

27. The method of claim 26, wherein heating the pyrolyzer comprises heating the pyrolyzer to a temperature of at least 450° C.

28. The method of claim 27, wherein heating the vaporizer comprises heating the vaporizer to a temperature of 200° C. or less, the shape of the vapor transport conduit preventing the infrared radiation from the pyrolyzer from increasing the temperature of the vaporizer.

29. The method of claim 26, further comprising:
maintaining a temperature of the deposition chamber at 50° C. or less without cooling the deposition chamber, the shape of the reactive species transport conduit preventing the infrared radiation from the pyrolyzer from increasing the temperature of the deposition chamber.

30. The method of claim 29, wherein maintaining the temperature of the deposition chamber comprises maintaining the temperature of the deposition chamber at 30° C. or less.
